(19) United States
(12) Patent Application Publication
(10) Pub. No.: US 2024/0062070 A1
(43) Pub. Date: Feb. 22, 2024

(54) SKILL DISCOVERY FOR IMITATION LEARNING

(71) Applicant: NEC Laboratories America, Inc., Princeton, NJ (US)

(72) Inventors: Wenchao Yu, Plainsboro, NJ (US); Haifeng Chen, West Windsor, NJ (US); Tianxiang Zhao, State College, PA (US)

(21) Appl. No.: 18/450,799

(22) Filed: Aug. 16, 2023

Related U.S. Application Data
(60) Provisional application No. 63/398,648, filed on Aug. 17, 2022.
(60) Provisional application No. 63/414,056, filed on Oct. 7, 2022.

(51) Int. Cl. G06N 3/092; G06N 3/045

(52) U.S. Cl. CPC G06N 3/092; G06N 3/045

(57) ABSTRACT

Methods and systems for training a model include performing skill discovery, using a set of demonstrations that includes known-good demonstrations and noisy demonstrations, to generate a set of skills. A unidirectional skill embedding model is trained in a first training while parameters of a skill matching model and low-level policies that relate skills to actions are held constant. The unidirectional skill embedding model, the skill matching model, and the low-level policies are trained together in an end-to-end fashion in a second training.

### RELATED APPLICATION INFORMATION

This application claims priority to U.S. Patent Appl. No. 63/398,648, filed on Aug. 17, 2022, and to U.S. Patent Appl. No. 63/414,056, filed on Oct. 7, 2022, incorporated herein by reference in its entirety.

### BACKGROUND

### Technical Field

The present invention relates to machine learning and, more particularly, to imitation learning.

### Description of the Related Art

In imitation learning, a model is trained using demonstrations of a given act. It may be challenging to collect a large number of high-quality demonstrations, such that a relatively small number of high-quality demonstrations may be available, contrasted to a larger number of noisy demonstrations. Noisy demonstrations may not follow the best strategy in selecting an action, and so may lead to inaccurately trained models.

### SUMMARY

A method of training a model includes performing skill discovery, using a set of demonstrations that includes known-good demonstrations and noisy demonstrations, to generate a set of skills. A unidirectional skill embedding model is trained in a first training while parameters of a skill matching model and low-level policies that relate skills to actions are held constant. The unidirectional skill embedding model, the skill matching model, and the low-level policies are trained together in an end-to-end fashion in a second training.

A system for training a model includes a hardware processor and a memory that stores a computer program. When executed by the hardware processor, the computer program causes the hardware processor to perform skill discovery, using a set of demonstrations that includes known-good demonstrations and noisy demonstrations, to generate a set of skills. A unidirectional skill embedding model is trained in a first training while parameters of a skill matching model and low-level policies that relate skills to actions are held constant. The unidirectional skill embedding model, the skill matching model, and the low-level policies are trained together in an end-to-end fashion in a second training.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an exemplary environment where an agent uses skills to achieve an objective, in accordance with an embodiment of the present invention;

FIG. 2 is a block/flow diagram of a method for discovering skills from a combined set of expert demonstrations and noisy demonstrations, in accordance with an embodiment of the present invention;

FIG. 3 is an example of pseudo-code for performing skill-based imitation learning from noisy demonstrations, in accordance with an embodiment of the present invention;

FIG. 4 is an example of pseudo-code for performing mutual information-augmented skill discovery, in accordance with an embodiment of the present invention;

FIG. 5 is a block/flow diagram of a method for training a skill prediction model, in accordance with an embodiment of the present invention;

FIG. 6 is a block/flow diagram of a method for performing skill discovery, in accordance with an embodiment of the present invention;

FIG. 7 is a block/flow diagram of a method for using a trained high-level policy and low-level policy to perform skill prediction, in accordance with an embodiment of the present invention;

FIG. 8 is a block diagram of a computing system that can perform skill discovery and selection, in accordance with an embodiment of the present invention;

FIG. 9 is a diagram of an exemplary neural network architecture that can be used in a policy model, in accordance with an embodiment of the present invention; and

FIG. 10 is a diagram of an exemplary deep neural network architecture that can be used in a policy model, in accordance with an embodiment of the present invention.

### DETAILED DESCRIPTION OF PREFERRED EMBODIMENTS

Imitation learning can be performed using a combination of high-quality expert demonstrations and more plentiful noisy demonstrations. Useful information may be extracted from the noisy demonstrations using a hierarchical training approach, where latent skills behind the generation of demonstrations may be discovered.

Demonstrations may encode particular skills or action primitives. A noisy demonstration may include both optimal skills and sub-optimal skills. The latent skill set may be discovered from both the expert demonstrations and the noisy demonstrations. The high-quality segments of the noisy demonstrations may be similar to segments of the expert demonstrations, while low-quality segments of the noisy demonstrations may be modeled by other skills. After the skills are learned, an agent model can be trained using the high-quality skills. This approach learns from the noisy demonstration set and further provides better interpretability by analyzing the encoded skills.

The present embodiments may be used in a variety of scenarios, providing an improvement to any application of imitation learning. For example, in healthcare scenarios, sequential medical treatments of a patient may be regarded as expert demonstrations, with state variables that include health records and symptoms and with actions being the application of particular treatments. The demonstrations where the patient fully recovers may be identified as expert demonstrations, while others can be identified as noisy demonstrations. Thus, the expert demonstrations may include known-good outcomes, while all other outcomes may be classified as noisy demonstrations that may have sub-optimal outcomes.

In another domain, imitation learning may be applied to navigation for self-driving vehicles. In such an example, the state may be the position and speed of the vehicle and the surrounding objects, while the action may be a navigation action that changes the direction or speed of the vehicle. In such a case, an expert demonstration may be one where the vehicle operates in a safe manner, in accordance with all applicable laws, while a noisy demonstration may be one where some error is committed.

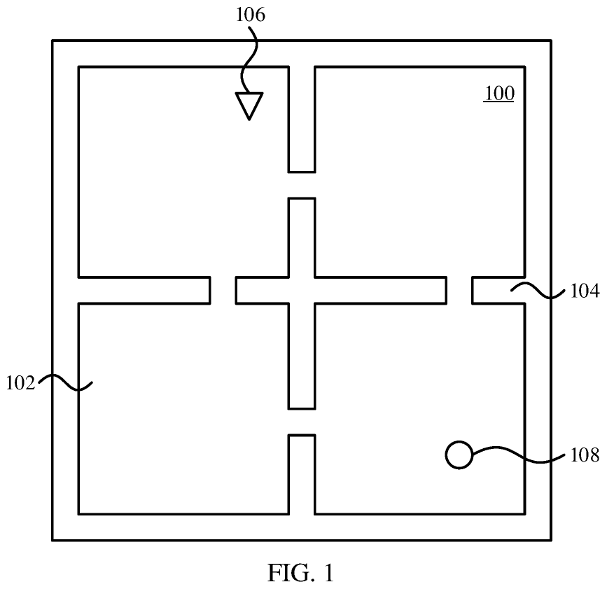

Referring now to FIG. 1, an exemplary environment 100 is shown where reinforcement learning may be performed. The environment 100 includes a grid of open spaces 102 and obstructions 104. An agent 106 maneuvers within the environment, for example performing actions such as turning and moving. A goal position 108 represents a target that the agent 106 attempts to reach.

Reinforcement learning can provide training for an agent model for sequential decision-making tasks, such as moving the agent 106 through the environment 100. However, reinforcement learning may be inefficient in using online environment interactions to specify rewards for agent behaviors. In contrast, imitation learning makes use of offline learning to leverage collected expert demonstrations. Imitation learning may learn an action policy by mimicking the latent generation process represented by the expert demonstrations.

Following the above example, each demonstration may represent a path of the agent 106 through the environment 100 to reach the goal position 108. Expert demonstrations may include paths where the agent 106 successfully reaches the goal 108, while noisy demonstrations may include paths where the agent 106 arrives elsewhere in the environment 100.

In another example in the medical domain, a trajectory may represent a series of treatments applied to a patient, broken up into time increments (e.g., four hours). The state may be represented as a set of relevant physiological features, including static and dynamic features, as well as historical treatments. Trajectories that resolve with a fully recovered patient may be interpreted as expert demonstrations, while all other trajectories may be interpreted as noisy demonstrations.

Hierarchical reinforcement learning may be used to decompose the full control policy of a reinforcement learning model into multiple macro-operators or abstractions, each encoding a short-term decision-making process. The hierarchical structure provides intuitive benefits for easier learning and long-term decision-making, as the policy is organized along the hierarchy of multiple levels of abstraction. Within the hierarchy, a higher-level policy provides conditioning variables or selected sub-goals to control the behavior of lower-level policy models.

In imitation learning, a policy π_{θ} may be learned from a collected demonstration set. Each demonstration τ is a trajectory, represented as a sequence of transitions described as state-action pairs: τ=(s₀, a₀, s₁, a₁, . . . ), with sₜ∈ [symbol] and aₜ∈ [symbol] respectively being the state and action at a time step t within the state space [symbol] and the action space [symbol] . A policy π: [symbol] × [symbol] →[0,1] maps the observed state to a probability distribution over actions. While expert demonstrations may be assumed to be optimal, noisy demonstrations may be available in greater quantity.

In particular, an expert demonstration set [symbol] ₑₓₚₑᵣₜ={τᵢ}ᵢ₌₁ⁿ^{ₑ} may be drawn from an expert policy πₑ, while a noisy demonstration set [symbol] _{noisy}={τᵢ}ᵢ₌₁ⁿ^{ₒ} may be drawn from other behavioral policies, where nₑ is a number of expert demonstrations in the set and nₒ may be a number of noisy demonstrations. The qualities of the policies used by [symbol] _{noisy} are not evaluated herein, and could be similar to the expert policy πₑ or could be significantly worse than the expert policy. A policy agent π_{θ} may be learned by extracting useful information from the expert demonstration set [symbol] ₑₓₚₑᵣₜ and the noisy demonstration set [symbol] _{noisy}.

The demonstrations, both expert and noisy, may be generated from a set of semantically meaningful skills, with each skill encoding a particular action primitive that may be expressed as a sub-policy. For example, in the healthcare domain, each skill could represent a strategy of adopting treatment plans in the context of particular symptoms. Demonstrations in [symbol] _{noisy} can be split into multiple segments, and useful information can be extracted from segments that are generated from high-quality skills. This task can be formalized as, given the expert demonstration set [symbol] ₑₓₚₑᵣₜ and a relatively large noisy demonstration set [symbol] _{noisy}, a policy agent π_{θ} for action prediction is learned based on the observed states.

The policy π_{θ} may be expressed as a combination of a high-level policy and a low-level policy. The high-level policy maintains a skill set and selects skills based on the observed state of a system, while the low-level policy decides on actions based on the skill. This framework provides for the automatic discovery of skills used by the sup-optimal noisy demonstrations. Thus skill discovery is performed using the union of [symbol] ₑₓₚₑᵣₜ and [symbol] _{noisy} to extract and refine a skill set with variable optimality. The learned skills may then be adapted to imitate [symbol] ₑₓₚₑᵣₜ, transferring the knowledge to learn the expert policy π_{θ}. Given an observation, the high-level policy selects the low-level policy and takes its output as the predicted action to enact. The high-level policy is optimized based on the quality of the selected actions, with the objective of maximizing long-term rewards.

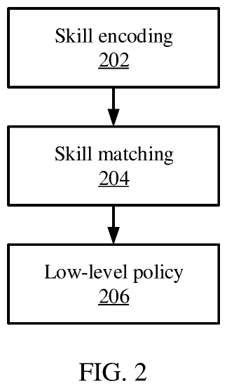

Referring now to FIG. 2, a high-level diagram of skill discovery is shown. A set of variables z^{k}∈ [symbol] ^{d}^{_{z}} is used to parameterize skills, where k=[1, . . . , K], d_{z} is the dimension of skill embeddings, and K is a total number of skill variables. As noted above, inference follows two steps: a high-level policy π_{high} that selects the skill zₜ for time step t based on historical transitions, and a low-level skill-conditioned policy π_{low} that predicts the actions to be taken. The high-level policy and the low-level policy model may both be implemented as multilayer perceptron neural networks. The number of layers for these models may depend on the complexity of the target task.

The high-level policy may include skill encoding 202 and skill matching 204. Skill encoding 202 maps historical transitions and current states to the skill embedding space [symbol] ^{d}^{_{z}}. The state sₜ and a sequence of state-action pairs [s_{t-M}, a_{t-M}, . . . , sₜ₋₁, aₜ₋₁] are used as input to obtain a latent skill embedding z′ₜ, where M is the length of a look-back window. States of the next step sₜ₊₁ may be used to enable quick skill discovery to account for transition dynamics. The state sₜ₊₁ is used as an auxiliary input during skill discovery, and an encoder can be modeled as p_{ƒ}_{_{bi}} (z′ₜ|s_{t-M}, a_{t-M}, . . . , sₜ₊₁, aₜ₊₁). During a skill reuse phase, future states will not be available, and the encoder may be modeled as p_{ƒ}_{ᵤₙᵢ}(z′ₜ|s_{t-M}, a_{t-M}, . . . , sₜ₊₁, aₜ₊₁).

Skill matching 204 maintains a set of K prototypical embeddings {z¹, z², . . . , z^{K}} as K skills. In the inference of time step t, the extracted skill embedding z′ₜ is compared to these prototypes and is mapped to one of them to generate zₜm, with the distribution probability as:

$$p ( {z}_{t} = {z}^{k} ) = \frac{1 / D ( {z}_{t}^{′} , {z}^{k} )}{{\sum }_{i = 1}^{K} 1 / D ( {z}_{t}^{′} , {z}^{i} )}$$

where D(⋅) is a distance measurement in the skill embedding space, such as a Euclidean distance metric. To encourage the separation of skills and to increase interpretability, hard selection may be used in the generation of zₜ.

To this end, a Gumbel softmax may be used, in which the index of the selected z is obtained following:

$${index}_{z} = arg {max}_{i} \frac{{e}^{{G}_{i} + log ( p ( {z}_{t} = {z}^{i} ) ) / ϵ}}{{\sum }_{j} {e}^{{G}_{j} + log ( p ( {z}_{t} = {z}^{j} ) ) / ϵ}}$$

where Gᵢ is sampled from the Gumbel distribution and ∈ here represents a temperature (e.g., set to 1). Reparameterization makes differentiable inference possible, so that prototypical skill embeddings may be updated along with other parameters in the learning process.

The low-level policy 206 captures the mapping from state to actions, conditioned on the latent skill variable, taking the state sₜ and skill variable zₜ as inputs and predicting the action p_{π}_{_{low}}(aₜ|sₜ, zₜ). An imitation learning loss may be determined as:

[symbol]

ᵢₘᵢ=− [symbol] _{τ}_{ᵢ} [symbol] ₍ₛ_{ₜ}_{,a}_{ₜ}_{)∈τ}_{ᵢ} [symbol] _{z}_{ₜ}_{˜π}_{_{high}} log p_{π}_{_{low}}(aₜ|sₜ, zₜ)

where [symbol] is the expectation value. This loss function takes a hierarchical structure and maximizes action prediction accuracy on given demonstrations.

The high-level policy π_{high} may be modeled by bi-directional skill encoding ƒ_{bi}(⋅) and skill matching g(⋅) in the first phase, and by unidirectional skill encoding ƒᵤₙᵢ and skill matching g(⋅) in the second phase.

During skill discovery, demonstrations of [symbol] ₑₓₚₑᵣₜ∪ [symbol] _{noisy} may be targeted with the hierarchical framework, modeling dynamics in action-taking strategies with explicit skill variables. However, using the imitation loss [symbol] ᵢₘᵢ directly is insufficient to learn a skillset of varying optimality.

Each skill variable zₜ may degrade to modeling an average of the global policy, instead of capturing distinct action-taking strategies from each other. A sub-optical high-level policy could tend to select only a small subset of skills or could query the same skill for very different states. Furthermore, as collected transitions are of varying qualities, the extracted skill set may include both high-quality skills and low-quality skills. The ground-truth optimality scores of the transitions from [symbol] _{noisy} are unavailable, posing additional challenges in differentiating and evaluating these skills.

To address these challenges, the discovery of specialized skills, distinct from one another, can be encouraged using a mutual information-based regularization term. To guide the skill selection and to estimate segment optimality, skill discovery may be implemented using deep clustering and skill optimality estimation may be implemented with positive-unlabeled learning. The future state sₜ₊₁ is incorporated during skill encoding to take the inverse skill dynamics into consideration.

To encourage the discovery of distinct skills, mutual information-based regularization may be used in skill discovery. Each skill variable z^{k} should encode a particular action policy, corresponding to the joint distribution of states and actions p(s, a|z^{k}). From this observation, the mutual information may be maximized between the skill z and the state action pair {s, a}: max I((s, a), a). Mutual information measures the mutual dependence between two variables and may be expressed as:

$$I ( ( s , a ) , z ) = {\int }_{𝒮 \times 𝒜} {\int }_{𝒵} p ( s , a , z ) \cdot log \frac{p ( s , a , z )}{p ( s , a ) \cdot p ( z )} d ( s , a ) dz$$

where p(s, a, z) is the joint distribution probability and p(s, a) and p(z) are the marginals. The mutual information objective can quantify how much can be known about (s, a) give z or, symmetrically, how much can be known about z given the transition (s, a). Maximizing this objective corresponds to encouraging each skill variable to encode an action-taking strategy that is identifiable and maximizing the diversity of the learned skill set.

Mutual information cannot be readily computed for high-dimensional data due to the probability estimation and integration in the formula above. Mutual information may be estimated for a regularization term as:

[symbol]

ₘᵢ= [symbol] ₜ_{ᵢ} [symbol] ₛ_{ₜ}_{,a}_{ₜ}_{∈τ}_{ᵢ} [ [symbol] _{z}_{ᵢ}+sp(−T(sₜ, aₜ, zᵢ⁺))+ [symbol] _{z}_{ᵢ}+sp(T(sₜ, aₜ, zᵢ⁻))]

where T(⋅) is a compatibility estimation function implemented as, e.g., a multi-layer perceptron, and sp(⋅) is a softplus activation function. The term zᵢ⁺ represents the skill selected by (sᵢ, aᵢ) that is a positive pair of (sₜ, aₜ), while zᵢ⁻ denotes the skill selected by (sᵢ, aᵢ) that is a negative pair of (sₜ, aₜ). A positive pair denotes a transition that is similar to (sₜ, aₜ) in both embedding and optimality quality, whereas a negative pair denotes the opposite. The mutual information regularization encourages different skill variables to encode different action policies, so that positive pairs should select similar skills, while negative skills should select different skills.

The optimization of mutual information regularization needs positive and negative pairs to learn a diverse skill set. In one example, zₜ may be used in place of zᵢ⁺, with the negative pair being randomly sampled skills from other transitions. However, such a strategy neglects potential guiding information and may select transitions using the same skill as negative pairs, introducing noise into the learning process. Instead of random sampling, heuristics may include similarity and estimated optimality of transitions.

A dynamic approach may be used for identifying positive and negative pairs based on these two heuristics. A deep clustering can discover latent groups of transitions and can capture their similarities, which will encourage different skill variables to encode action primitives of different transition groups. A positive-unlabeled learning uses both [symbol] ₑₓₚₑᵣₜ and [symbol] _{noisy} to evaluate the optimality of discovered skills and can propagate estimated optimality scores to transitions.

To find similar transitions, the distance in a high-dimensional space extracted by skill encoding ƒ_{bi} may be measured. The distance between (sₜ, aₜ) and (sᵢ, aᵢ) may be expressed as D(z′ₜ, zₜ). The candidate positive group for zₜ may be those transitions with a small distance from zₜ and the positive group may be those transitions with a large distance from zₜ, with the boundary being set by a predetermined threshold. For example, candidate positive samples may be the transitions having the top-15% smallest distance, while candidate negative samples may be the transitions having the top-50% largest distance. This encourages the transitions taken similarly by the skill encoding 202 to select similar skills and to avoid dissimilar skills. Measured distances in the embedding space may be noisy at the beginning, with their quality improving during training. A proxy is added by applying clustering directly to the input states, using variable ζ to control the probability of adopting the deep embedding cluster or the pre-computed version. The value of ζ may be gradually increased to shift from pre-computed clustering to the deep embedding clustering.

A pseudo optimality score can be used to refine candidate positive pairs with a positive-unlabeled learning scheme. As [symbol] _{noisy} includes sub-optimal demonstrations, with transitions taking imperfect actions, transitions of varying qualities are differentiated to imitate them with different skills. However, ground-truth evaluations of those transitions may be unavailable. Only the transitions from [symbol] ₑₓₚₑᵣₜ may be considered positive examples, while transitions from [symbol] _{noisy} may be considered unlabeled examples. The optimality scores of discovered skills may be estimated and may then be propagated to the unlabeled transitions.

The optimality score of skills may be estimated based on the preference of expert demonstrations and on the action prediction accuracy. Those skills preferred by expert demonstrations over noisy demonstrations and that have a high action prediction accuracy may be considered as being of higher quality. The scores may then be propagated to unlabeled transitions based on skill selection distributions. The estimated optimality score also evolves with the training process.

A skill selection distribution may be denoted as P^{z}={pₖ^{z}, k∈[1, . . . , K]}. The selection distribution of expert demonstrations may be selected as:

pₖ^{z,expert}= [symbol] [symbol] ₍ₛ_{ₜ}_{,a}_{ₜ}_{)∈τ}_{ᵢ}p(zₜ=z^{k})

The selection distribution of noisy demonstrations may be selected as:

pₖ^{z,noisy}= [symbol] [symbol] ₍ₛ_{ₜ}_{,a}_{ₜ}_{)∈τ}_{ᵢ}p(zₜ=z^{k})

The expert preference score sₖ^{pref} of skill k can be determined as (pₖ^{z,noisy}−pₖ^{z,noisy})/(pₖ^{z,clean}+δ), where δ is a small constant to prevent division by zero.

The quality score of each skill can be computed based on its action-prediction accuracy when selected:

sₖ^{qual}= [symbol] _{τ}_{ᵢ} [symbol] ₍ₛ_{ₜ}_{,a}_{ₜ}_{)∈τ}_{ᵢ} [symbol] _{z}_{ₜ}_{=z}_{^{k}}p(aₜ|sₜ, z^{k})

The estimated optimality score sₖ^{op} of skill k can be determined by normalizing the product of the two scores, sₖ^{pref}·sₖ^{qual}, into the range [−1,1]. With the evaluated skills, optimality scores may be propagated to each transition of [symbol] _{noisy} based on the skill it selects and its performance. For transition (sₜ, aₜ), the optimality may be computed as Σₖ₌₁^{K}p(zₜ=z^{k}). sₖ^{op}.

All of the transitions in [symbol] ₑₓₚₑᵣₜ may have an optimality score of 1. The candidate positive group of zₜ may be refined by removing those that have a very different optimality score, for example using a threshold ∈. This process is not needed for the candidate negative group, as they should be encouraged to select different skills regardless of optimality. The estimation of skill optimality scores is updated every N_{PU} epochs during training to reduce instability.

Latent action-taking strategies can be discovered from collected demonstrations and explicitly encoded. Due to the lack of ground-truth optimality scores for [symbol] _{noisy}, it can be difficult for skill encoding 202 to tell these transitions apart to differentiate their latent skills. Therefore sₜ₊₁ can be included as n input to skill encoding 202 so that skills can be encoded in an influence-aware manner. The use of sₜ₊₁ enables skill selection to be conditioned not only on current and prior trajectories, but also on a future state, which can help to differentiate skills that work in similar states. This bidirectional skill encoder ƒ_{bi} is used during skill discovery and so will not produce problems with information leakage.

Thus, in skill discovery, skill encoding 202, skill matching 204, and the low-level policy 206 may be trained on [symbol] ₑₓₚₑᵣₜ∪ [symbol] _{noisy}, with mutual information loss [symbol] ₘᵢ being used to encourage the learning of a diverse skill set. The similarity and optimality of transitions may be determined as described in greater detail. The full learning objective function may be expressed as:

$${min}_{{f}_{b i} , g , {π}_{low}} {max}_{T} {ℒ}_{i m i} + {λℒ}_{m i}$$

where T is the compatibility estimator described above with respect to mutual information estimation and λ is a hyperparameter.

With skill discovery completed, the learned skill set is used to imitate expert demonstrations in [symbol] ₑₓₚₑᵣₜ. The functions ƒᵤₙᵢ(⋅), g(⋅), and π_{low}(⋅) are adapted by imitating [symbol] ₑₓₚₑᵣₜ. Concretely, as ƒ_{bi}(⋅), g(⋅), and π_{low}(⋅) are already learned during skill discovery, skill reuse may be split into two steps. In a first step, the parameters of g(⋅) and π_{low}(⋅) may be frozen, as these contain the extracted skills and skill-conditioned policies, and only ƒᵤₙᵢ(⋅) is trained on [symbol] ₑₓₚₑᵣₜ to obtain a high-level skill selection policy. This step uses pre-trained skills to mimic expert demonstrations. The skill selection knowledge from ƒ_{bi} to ƒᵤₙᵢ may be transferred with an appropriate loss term:

[symbol]

_{KD}= [symbol] _{τ}_{ᵢ} [symbol] ₍ₛ_{ₜ}_{,a}_{ₜ}_{)∈τ}_{ᵢ}p(zₜ=z̅ₜ)

in which z̅ₜ is predicted using ƒ_{bi}. The weight of [symbol] _{KD} need not be manipulated, as it has the same scale as [symbol] ᵢₘᵢ. The learning objective for this phase is thus:

$${min}_{{f}_{u n i} , g , {π}_{low}} {ℒ}_{i m i} + {ℒ}_{KD}$$

In the second step, the whole framework may be refined in an end-to-end manner based on the imitation objective [symbol] ᵢₘᵢ.

Aside from fine-tuning the skill-based framework on [symbol] ₑₓₚₑᵣₜ, the transitions from [symbol] _{noisy} having a low optimality score may further be used. During skill discovery, positive-unlabeled learning may be conducted iteratively to evaluate the quality of transitions from [symbol] _{noisy} to assign an optimality score to each. Transitions with low optimality scores from [symbol] _{noisy} may be extracted to a new set [symbol] _{neg}, and an optimization objective [symbol] _{adv} may be used to encourage the agent to account for these demonstrations:

$${min}_{{f}_{uni , g , {π}_{low}}} {ℒ}_{adv} = {𝔼}_{( {s}_{t} , {a}_{t} ) ∈ {𝒟}_{neg}} log p ( {a}_{t} \vert {s}_{t} , {z}_{t} )$$

Using a hard threshold to collect D_{neg}, the learning objective becomes [symbol] ᵢₘᵢ+ [symbol] _{adv}. This objective encourages the model to avoid actions similar to the low-quality demonstrations.

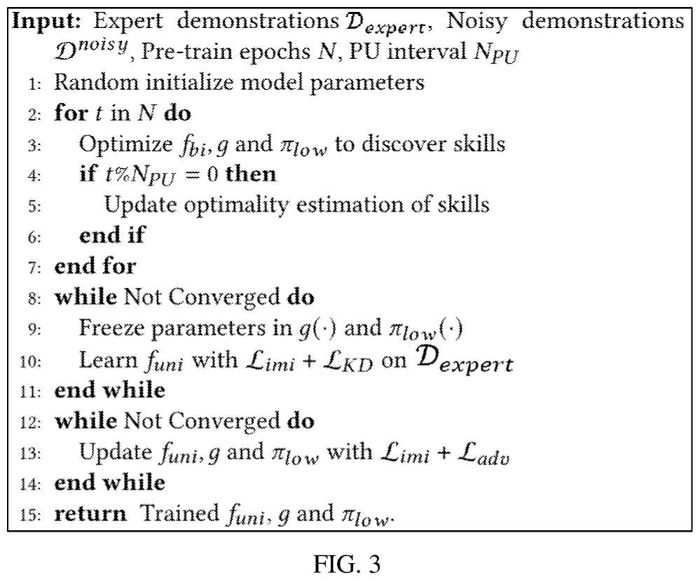

Referring now to FIG. 3, pseudo-code for skill-based imitation learning is shown. Skill discovery is represented in lines 2-7 of FIG. 3, with details of learning with mutual information-based regularization being described in greater detail below. This regularization helps skill discovery imitation learning to learn a set of disentangled skills. During skill reuse, the learned skills are frozen to update the high-level policy in lines 8-11. The framework is fine-tuned in an end-to-end fashion in lines 12-14.

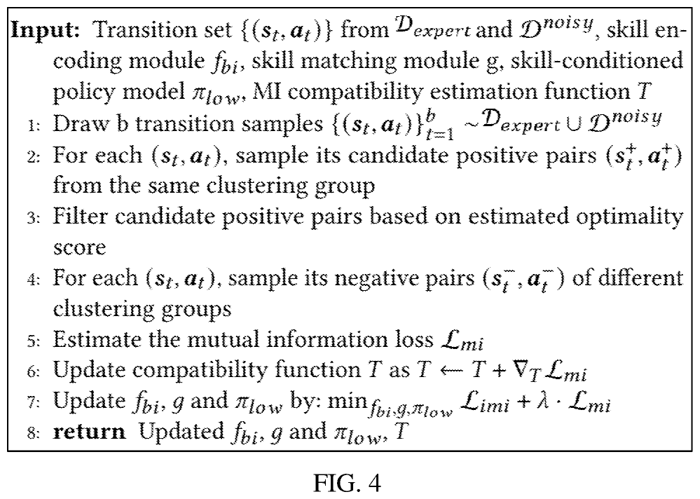

Referring now to FIG. 4, pseudo-code for mutual information-augmented skill discovery is shown. This process performs regularization based on mutual information, as described above.

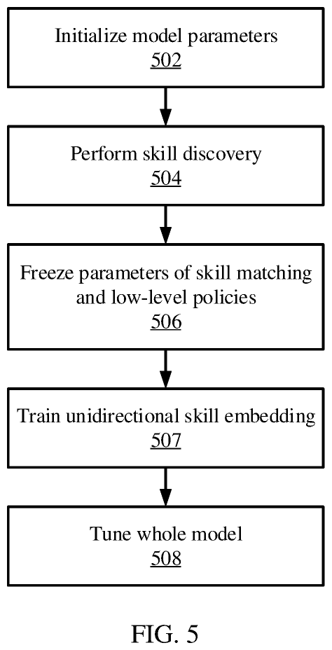

Referring now to FIG. 5, a training process based on skill discovery is shown. The model parameters are initialized in block 502, for example using a randomized initialization. Block 504 performs skill discovery for a predetermined number of pre-training epochs. Block 506 then freezes the parameters of the skill matching and low-level policy models while the unidirectional skill encoding model ƒᵤₙᵢ is updated using the set of expert demonstrations [symbol] ₑₓₚₑᵣₜ in block 507. Block 508 then tunes all parameters of the model, including the unidirectional skill encoding model ƒᵤₙᵢ, the skill matching model g, and the low-level policies π_{low}.

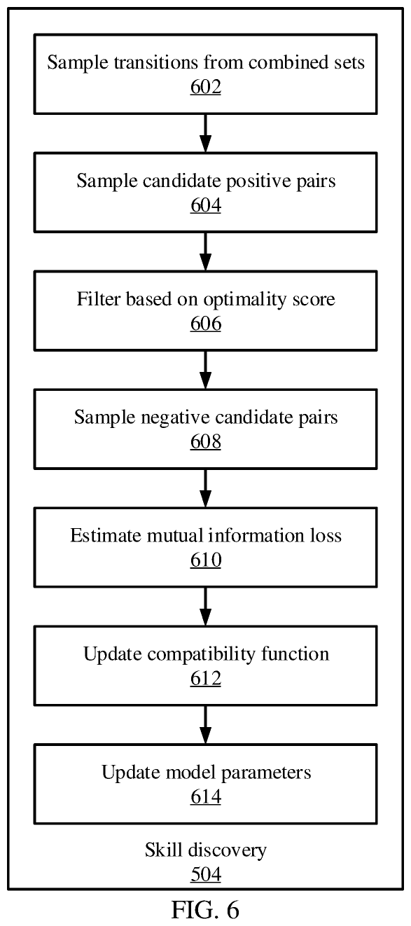

Referring now to FIG. 6, additional detail on skill discovery 504 is shown. The combined set of transitions, [symbol] ₑₓₚₑᵣₜ∪ [symbol] _{noisy}, is sampled 602 to generate b transition samples {(sₜ, aₜ)}ₜ₌₁^{b}. For each pair (sₜ, aₜ), block 604 samples candidate positive pairs (sₜ⁺, aₜ⁺) from a same clustering group. Block 606 then filters candidate positive pairs based on an estimated optimality score, as described above.

Block 608 samples negative pairs (sₜ⁻, aₜ⁻) for each (sₜ, aₜ) from different clustering groups. The mutual information loss [symbol] ₘᵢ may then be estimated in block 610 and the compatibility function T can be updated as T←T+∇_{T} [symbol] ₘᵢ. The bidirectional skill encoding model ƒ_{bi}, skill matching model g, and low-level policies π_{low} can then be updated with the objective function

$${min}_{{f}_{b i} , g , {π}_{low}} {ℒ}_{imi} + {λℒ}_{m i} .$$

The compatibility function may be optimized to maximize the mutual information loss, for example using gradient back propagation.

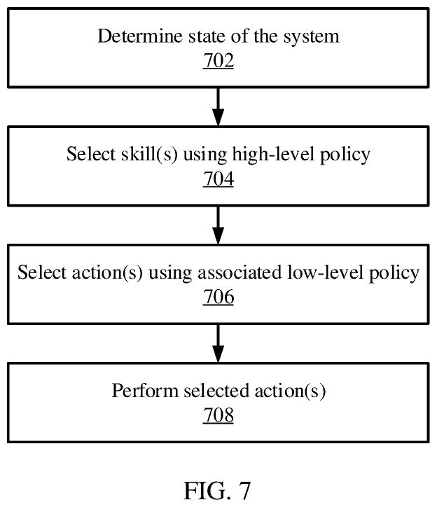

Referring now to FIG. 7, a method for using a trained imitation learning skill-based model is shown. Block 702 determines the state of the system. The state of the system may depend on what type of system is being considered. Following the example of FIG. 1 above, the state may represent the position of an agent 106 and its orientation, but may also include known contextual information such as the positions of any walls 104 that the agent 106 has encountered. In an example relating to medical treatments, the state of the system may include information about a patient. That information may include static information, such as the patient's age and height, and may also or alternatively include dynamic information, such as recent measurements of the patient's vital signs. In an example that includes a self-driving vehicle, the state of the system may include information about the vehicle, such as speed, and information about the surroundings, such as detected objects, vehicles, and obstacles.

Block 704 selects a skill from the high-level policy. As noted above, the high-level policy maintains a skill set and selects skills based on the observed state of the system. Based on the skill, a low-level policy selects one or more actions to take in block 706. Block 708 then performs the selected action(s).

These actions may include any appropriate procedure that the agent 106 can perform within the environment 100. For a robot, the action may include changing direction, moving, or otherwise interacting with the environment. For a medical context, the action may include a particular treatment to be administered to the patient. For a self-driving vehicle, the action may include steering, acceleration, or braking.

The action may be automatically performed by the agent 106, without any further intervention by a human being. For example, the robot or self-driving vehicle may automatically maneuver within its environment 100. In a medical context, a treatment system may automatically administer an appropriate medication, for example using an IV line. Using the model may include a two-step process of selecting a suitable skill and then predicting the action to take using the skill.

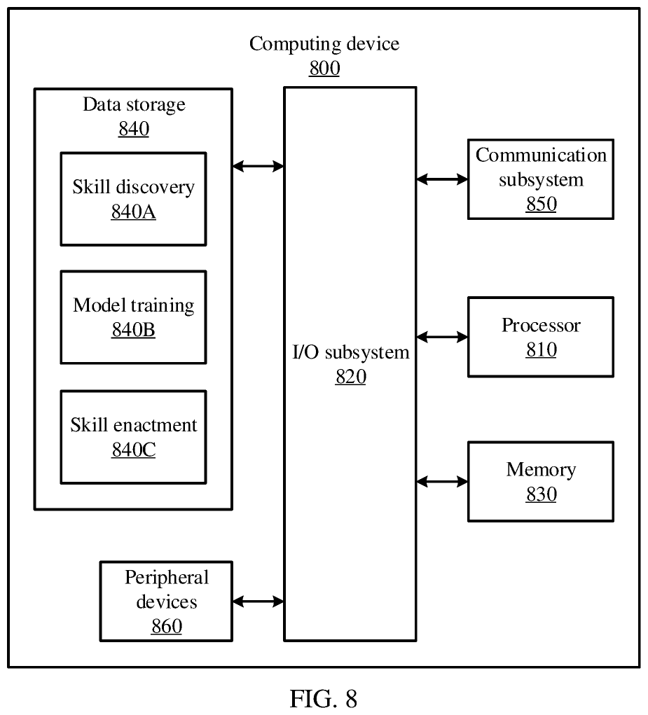

Referring now to FIG. 8, an exemplary computing device 800 is shown, in accordance with an embodiment of the present invention. The computing device 800 is configured to perform model training and action selection.

The computing device 800 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 800 may be embodied as one or more compute sleds, memory sleds, or other racks, sleds, computing chassis, or other components of a physically disaggregated computing device.

As shown in FIG. 8, the computing device 800 illustratively includes the processor 810, an input/output subsystem 820, a memory 830, a data storage device 840, and a communication subsystem 850, and/or other components and devices commonly found in a server or similar computing device. The computing device 800 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 830, or portions thereof, may be incorporated in the processor 810 in some embodiments.

The processor 810 may be embodied as any type of processor capable of performing the functions described herein. The processor 810 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 830 may be embodied as any type of volatile or non-volatile memory or data storage capable of performing the functions described herein. In operation, the memory 830 may store various data and software used during operation of the computing device 800, such as operating systems, applications, programs, libraries, and drivers. The memory 830 is communicatively coupled to the processor 810 via the I/O subsystem 820, which may be embodied as circuitry and/or components to facilitate input/output operations with the processor 810, the memory 830, and other components of the computing device 800. For example, the I/O subsystem 820 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 820 may form a portion of a system-on-a-chip (SOC) and be incorporated, along with the processor 810, the memory 830, and other components of the computing device 800, on a single integrated circuit chip.

The data storage device 840 may be embodied as any type of device or devices configured for short-term or long-term storage of data such as, for example, memory devices and circuits, memory cards, hard disk drives, solid state drives, or other data storage devices. The data storage device 840 can store program code 840A for skill discovery, 840B for training the model, and/or 840C for enacting a predicted skill. Any or all of these program code blocks may be included in a given computing system. The communication subsystem 850 of the computing device 800 may be embodied as any network interface controller or other communication circuit, device, or collection thereof, capable of enabling communications between the computing device 800 and other remote devices over a network. The communication subsystem 850 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 800 may also include one or more peripheral devices 860. The peripheral devices 860 may include any number of additional input/output devices, interface devices, and/or other peripheral devices. For example, in some embodiments, the peripheral devices 860 may include a display, touch screen, graphics circuitry, keyboard, mouse, speaker system, microphone, network interface, and/or other input/output devices, interface devices, and/or peripheral devices.

Of course, the computing device 800 may also include other elements (not shown), as readily contemplated by one of skill in the art, as well as omit certain elements. For example, various other sensors, input devices, and/or output devices can be included in computing device 800, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 800 are readily contemplated by one of ordinary skill in the art given the teachings of the present invention provided herein.

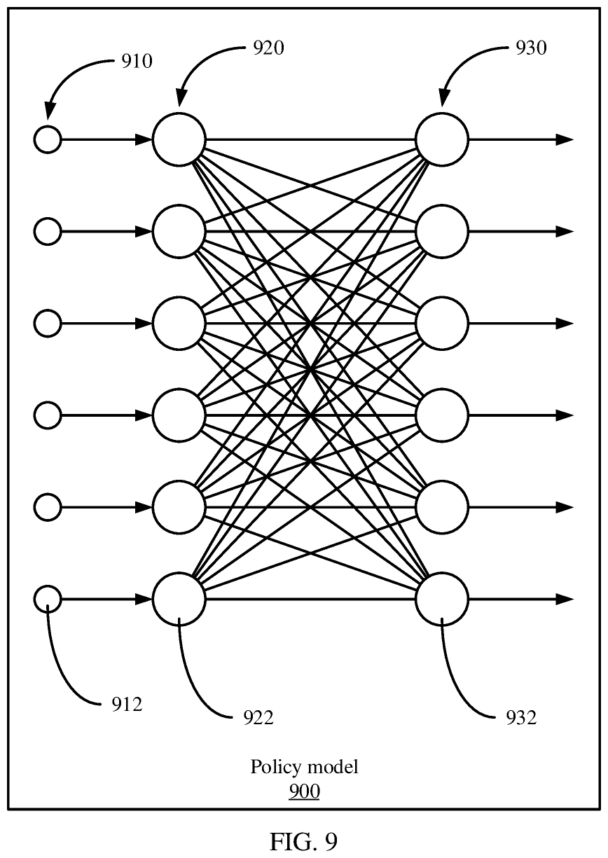

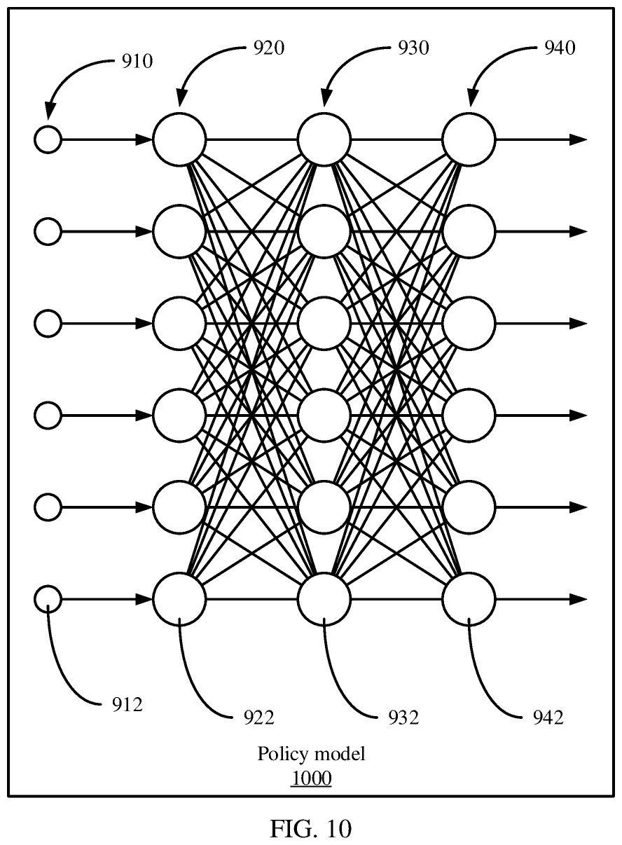

Referring now to FIGS. 9 and 10, exemplary neural network architectures are shown, which may be used to implement parts of the present models, such as policy models 900 and 1000. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 920 of source nodes 922, and a single computation layer 930 having one or more computation nodes 932 that also act as output nodes, where there is a single computation node 932 for each possible category into which the input example could be classified. An input layer 920 can have a number of source nodes 922 equal to the number of data values 912 in the input data 910. The data values 912 in the input data 910 can be represented as a column vector. Each computation node 932 in the computation layer 930 generates a linear combination of weighted values from the input data 910 fed into input nodes 920, and applies a non-linear activation function that is differentiable to the sum. The exemplary simple neural network can perform classification on linearly separable examples (e.g., patterns).

A deep neural network, such as a multilayer perceptron, can have an input layer 920 of source nodes 922, one or more computation layer(s) 930 having one or more computation nodes 932, and an output layer 940, where there is a single output node 942 for each possible category into which the input example could be classified. An input layer 920 can have a number of source nodes 922 equal to the number of data values 912 in the input data 910. The computation nodes 932 in the computation layer(s) 930 can also be referred to as hidden layers, because they are between the source nodes 922 and output node(s) 942 and are not directly observed. Each node 932, 942 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 932 in the one or more computation (hidden) layer(s) 930 perform a nonlinear transformation on the input data 912 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a model, comprising:
performing skill discovery, using a set of demonstrations that includes known-good demonstrations and noisy demonstrations, to generate a set of skills;
training a unidirectional skill embedding model in a first training while parameters of a skill matching model and low-level policies that relate skills to actions are held constant; and
training the unidirectional skill embedding model, the skill matching model, and the low-level policies together in an end-to-end fashion in a second training.

2. The method of claim 1, wherein skill discovery includes sampling positive and negative candidates for transition samples taken from the set.

3. The method of claim 2, wherein the positive candidates are sampled from a same clustering group and the negative candidates are sampled from a different clustering group.

4. The method of claim 2, wherein the positive candidates and the negative candidates are used to update a compatibility based on a mutual information.

5. The method of claim 4, wherein skill discovery includes training a bidirectional skill embedding model, the skill matching model, and the low-level policies using the mutual information.

6. The method of claim 1, wherein skill discovery is performed on a set of demonstrations that includes expert demonstrations with known-good outcomes and noisy demonstrations with sub-optimal outcomes.

7. The method of claim 6, wherein the expert demonstrations are made up of a set of expert skills and wherein the noisy demonstrations are made up of a combination of expert skills and sub-optimal skills.

8. The method of claim 7, wherein the first training is performed using only the expert skills.

9. The method of claim 7, wherein the second training is performed using the expert skills and the sub-optimal skills.

10. The method of claim 1, wherein the low-level policies are implemented as multilayer perceptron neural network models.

11. A system for training a model, comprising:
a hardware processor; and
a memory that stores a computer program which, when executed by the hardware processor, causes the hardware processor to:
perform skill discovery, using a set of demonstrations that includes known-good demonstrations and noisy demonstrations, to generate a set of skills;
train a unidirectional skill embedding model in a first training while parameters of a skill matching model and low-level policies that relate skills to actions are held constant; and
train the unidirectional skill embedding model, the skill matching model, and the low-level policies together in an end-to-end fashion in a second training.

12. The system of claim 11, wherein skill discovery includes a sampling positive and negative candidates for transition samples taken from the set.

13. The system of claim 12, wherein the positive candidates are sampled from a same clustering group and the negative candidates are sampled from a different clustering group.

14. The system of claim 12, wherein the positive candidates and the negative candidates are used to update a compatibility based on a mutual information.

15. The system of claim 14, wherein skill discovery includes a training of a bidirectional skill embedding model, the skill matching model, and the low-level policies using the mutual information.

16. The system of claim 11, wherein skill discovery is performed on a set of demonstrations that includes expert demonstrations with known-good outcomes and noisy demonstrations with sub-optimal outcomes.

17. The system of claim 16, wherein the expert demonstrations are made up of a set of expert skills and wherein the noisy demonstrations are made up of a combination of expert skills and sub-optimal skills.

18. The system of claim 17, wherein the first training is performed using only the expert skills.

19. The system of claim 17, wherein the second training is performed using the expert skills and the sub-optimal skills.

20. The system of claim 11, wherein the low-level policies are implemented as multilayer perceptron neural network models.
